(19) United States
(12) Patent Application Publication
(10) Pub. No.: US 2005/0181716 A1
(43) Pub. Date: Aug. 18, 2005

(54) Crustacean meat extraction

(76) Inventor: Stephen L. Gillespsie, Appleton, WI (US)

Correspondence Address: WILHELM LAW SERVICE, S.C., 100 W LAWRENCE ST, THIRD FLOOR, APPLETON, WI, 54911, US

(21) Appl. No.: 11/026,374

(22) Filed: Dec. 29, 2004

Related U.S. Application Data
(60) Provisional application No. 60/538,336, filed on Jan. 22, 2004.

(51) Int. Cl. A22C 29/02

(52) U.S. Cl. 452/2

(57) ABSTRACT

A crustacean shell opener, and methods, for opening elongate sections of crustacean shells. The opener cuts the shell with a thin blade, which directs a force inwardly into the shell, forming a slit without breaking off macro pieces of shell, rather than using impact or brute force pressure to break the shell. The user is shielded from the blade while a shell is opened. The opener comprises two arms, connected at a joint, extending in a generally common direction, with the blade extending from one arm toward the other. The first arm may extend beyond the second. The opener is fabricated from food grade material. The joint preferably includes an aperture to receive an elongate section of shell. The cutting edge preferably faces toward and/or away from the aperture. The opener can include meat extractors and preferably shields the user's fingers from the blade, to control injury.

### CROSS REFERENCE TO RELATED APPLICATIONS

This application is a Non-Provisional Application, claiming priority under 35 U.S.C. 119(e) to U.S. Provisional Application Ser. No. 60/538,336, filed Jan. 22, 2004, which is incorporated herein by reference in its entirety.

### BACKGROUND

The present invention relates generally to tools and methods for efficiently opening an elongate section of an exo-skeletal crustacean shell, and removing the meat from inside the crustacean shell.

For those who enjoy eating meat direct from crabs and/or other crustaceans, such as lobster or lungusta, one problem which must be overcome is the opening of the exo-skeleton/shell of the crustacean, as well as removing the meat from the exo-skeleton after the shell has been opened. In particular, blue crab and stone crab are prized for their especially tasty meat. In addition, legs of larger crabs, of lobster and lungusta, contain delectable morsels.

Such crustaceans commonly have a hard brittle shell, which makes retrieval of clean pieces of meat difficult in the small shell chambers. This, in part, explains the premium prices which “soft shell” crabs command in the market place, where there is no potential for shell pieces in the meat.

In conventional practice, the crustacean shell is opened using any of a variety of tools, typically a tool which was developed for application to another use, not opening crustacean shells. Exemplary of such conventionally-used tools are a wooden mallet, a conventional sharp knife, a nut cracker, a pair of pliers, a scissors, or a sharp pick or other sharp-pointed object. Such tools are difficult to use for retrieving meat from the shell, and can be dangerous to the user, and so the user may feel uncomfortable about giving such tools to children or other novices. In addition, opening the shell, or picking the meat, using such tools, frequently results in broken or shattered pieces of shell becoming mixed with the meat. Finally, broken and jagged edges of shell generated by the use of a mallet or knife can be hazardous; can injure the fingers and hands of the user.

In one method of the prior art for picking crab meat from crabs, the picker begins with removal of the legs and claws from the crab body. Next, with fingers, an apron on the underside of the crab body is pulled off and discarded. With the crab body in both hands, a thumb is inserted under the shell, and the top shell is pulled from the crab body. A spoon can be used to scrape soft roe and/or liver from within the top shell, if desired; whereafter the top shell is discarded. The body can also include roe or liver in a central cavity. This can be removed and saved, if desired, and the gills are then removed and discarded. The body of the crab is then cut or broken into two parts. The knife and/or mallet are typically used to cut and smash the portions of the shell sections or sub-chambers of the body so that the white crab meat can be picked from within. Since neither a conventional knife, nor a mallet, are well suited to working with the smaller parts of the crab, such as the legs, the legs are customarily discarded with their meat still inside.

Since the legs and other small-cavity parts of the crab body are discarded, a considerable amount potentially-usable product is wasted, thereby adding unnecessarily to the waste stream as well as foregoing the benefit/value of that potentially recoverable meat which is actually discarded.

In addition, the crab meat which is successfully retrieved from the shell almost always includes a substantial fraction of small fragments of contaminating shell material. These small bits of shell become mixed with the meat because of the uncontrolled manner of entry into the shell.

Such small/bits of shell reduce the value and quality of the meat, and can be hazardous to chew and swallow. Further, the person picking the crab meat is likely to get at least a few painful cuts and scratches from the jagged edges of the shell.

While a variety of special tools e.g. picks, have been designed for removal of crab meat from the small legs of e.g. blue crabs, such tools still do not solve the matter of the shell breaking in an uncontrolled manner whereby bits of shell mix with and contaminate the meat. Given the small size of such particles of contaminating shell, it is understood that, once the shell is present in the meat, there is no practical way of removing the shell particles from the meat.

It is an object of this invention to provide a tool for opening crab legs and other crustacean shell parts.

It is a more specific object to provide a tool for opening elongate sections of crustacean shell.

It is a still more specific object to provide a tool which can be used to open crustacean shells without generating substantial quantities of shell fragments which are susceptible of contaminating the meat inside the shell.

It is yet another object to provide a tool which can be used both to open a crustacean shell, especially a crab shell, cleanly and effectively, and to retrieve the meat inside the shell where the inner configuration of the shell is of limited size, such as the size of a leg of a crab or a lobster or a lungusta.

Still another object is to provide a tool which can be used to open a crustacean shell, such as a crab shell, wherein the process of opening the shell proceeds by advancing the point of opening entry into the shell along a generally predictable line of progression, and for a generally controllable distance.

Yet another object is to provide a tool which can be used to open a crustacean shell wherein the element of the tool which penetrates the shell has a sharp point and/or edge, and wherein, in typical use, the user's hand is generally shielded from accidental contact with such sharp point or edge.

A further object is to provide a tool which, in use, penetrates the crustacean shell without breaking individual macro-pieces of shell material away from the shell body, and which, after penetration, can be used to advance a cut along a controllable line of extension.

### SUMMARY

The invention generally comprises a shell opener for opening elongate and other section of crustacean shells, and for extracting the meat from such small cross-section shell cavities. While the invention can be used for opening shell cavities which are not elongate, the invention is specially designed and configured to facilitate opening the elongate sections, such as crab legs, lobster legs, lungusta legs, and the like.

The invention further provides a shell opener which operates generally on a principle of cutting the shell with a thin blade, rather than the prior art principles of breaking the shell by impact or by brute force pressure, such as would be applied by a mallet or a pair of pliers, or the scissoring action of a pair of scissors. While it is known to use a blade, e.g. a knife blade to open a crustacean shell, known blades and methods expose the user to potential injury should the blade slip.

By contrast, in the invention, the user is well protected/shielded from the blade at all times while a shell is being opened. In that regard, a first family of embodiments of the invention is represented by a shell opener which is adapted to open elongate sections of crustacean shells. The shell opener comprises first and second arms, the first and second arms having first and second respective lengths, the first and second arms being connected to each other at a joint therebetween, and extending in a generally common direction from the joint, the first arm having a first distal end remote from the joint, the second arm having a second distal end remote from the joint; and a shell cutting blade, for cutting crustacean shell, extending from one of the first and second arms toward the other of the first and second arms such that the cutting blade is adapted to make an elongate cut along the elongate section of crustacean shell as such elongate section is drawn along the length of the respective the arm.

In some embodiments, the shell opener is fabricated from food grade material suitable for contact with foodstuffs.

In preferred embodiments, the first and second arms are sufficiently resiliently flexible to enable a user thereof to bring the first and second arms together, thereby to penetrate the cutting blade into a crustacean shell positioned between the first and second arms.

In preferred embodiments, the shell cutting blade extends from, and is integral with, the respective said arm.

Also to preferred embodiments, the shell opener is fabricated from food-grade material, optionally selected from the group consisting of stainless steel, aluminum, titanium, coated steel, other cutlery-grade materials, and alloys of such metals.

In some embodiments, the first arm extends a first distance from the joint to the first distal end, the second arm extends a second distance from the joint to the second distal end, and the first distance is greater than the second distance, whereby a section of the first arm extends beyond the second distal end of the second arm.

In some embodiments, the section of the first arm which extends beyond the second arm is configured to retrieve leg meat from narrow openings in crab legs.

In preferred embodiments, the cutting blade is positioned and configured, relative to the respective one of the arms such that the cutting blade is brought into cutting engagement with a respective crustacean shell, which is positioned between the first and second arms, by urging the distal ends of the first and second arms toward each other.

In preferred embodiments, the urging of the distal ends of the first and second arms toward each other comprises pivoting the first and second arms relative to each other about the joint.

In preferred embodiments, the blade, in cutting the shell, applies force directed inwardly into the respective section of crustacean shell.

In preferred embodiments, the first and second arms, at rest, are biased away from each other, and are generally parallel to each other.

Also to preferred embodiments, the shell cutting blade is located on the respective arm at a location remote from the joint.

In preferred embodiments, the first and second arms comprise a unitary piece of material which extends, uninterrupted, through the joint.

In some embodiments, the invention further comprises meat extractors extending from one or both of the first and second arms, the meat extractor or extractors terminating at respective ends thereof. Where two extractors are used, the extractors are preferably opposed to each other such that the meat extractors can be brought together in a pinching relationship with respect to each other. The one or more meat extractors are sized and configured so as to facilitate entrance of the meat extractors into narrow sections of crab leg, with any meat extractors generally conforming to typical outlines of such narrow sections of crab leg, the meat extractors being effective for extracting crab meat from such narrow sections of crab leg.

In some embodiments, the meat extractors extend from the arms in directions transverse to the lengths of the first and second arms, and preferably extend no more than one inch from the respective arms.

In preferred embodiments, the first and second arms have respective first and second ends, and the first and second arms are inwardly curved proximate the first and second ends so that inner surfaces of the arms proximate the ends are concave, thereby to generally conform to a typically rounded outline of elongate sections of crustacean shells to be opened therewith.

In preferred embodiments, the opener further comprises an aperture extending through the shell opener at the joint so as to enable extending an elongate section of crustacean shell through the aperture in general alignment with the first and second arms.

Preferred embodiments have the shell cutting blade oriented with an effective cutting edge facing at least one of toward, or away from, the aperture.

In some embodiments, the first and second arms are biased away from each other against a stop.

In a second family of embodiments, the invention comprehends a method of opening a generally unopened elongate section of a crustacean body, having a first length. The method comprises aligning the unopened elongate section of the crustacean body with first and second arms of a opener for such crustacean bodies, and between the first and second arms, (i) the first and second arms having first and second respective lengths, and being connected to each other at a joint therebetween, and extending in a generally common direction from the joint, and (ii) a shell cutting blade extending from one of the first and second arms toward the other of the first and second arms; moving the first and second arms collectively toward each other to a relatively more closed position wherein the blade penetrates the crustacean body which is to be opened; and drawing the section of crustacean body in a direction along the lengths of the arms, with the cutting blade maintained in cutting relationship with the crustacean body, whereby the drawing of the crustacean body in the direction of the lengths of the arms, with the cutting blade maintained in cutting relationship with the crustacean body draws the shell into and through a cutting relationship with the blade and thereby effects cutting of an elongate slit along the length of the elongate section of the crustacean body.

In some embodiments, the blade cuts an elongate slit without breaking off macro-pieces of shell of the crustacean body.

In some embodiments, the opener further comprises a meat extractor extending from at least one of the first and second arms, the meat extractor terminating at an end. Where meat extractors are used on both arms, the extractors are opposed to each other, such that the meat extractors can be brought together in a pinching relationship with respect to each other, the meat extractors being sized and configured so as to facilitate entrance of the meat extractors into narrow sections of a crustacean body, and the meat extractors generally conform to the outlines of the narrow sections of the crustacean body, the method further comprising using the meat extractors of the opener to extract meat from the elongate section of the crustacean body.

In some embodiments, the opener further comprises an aperture extending through the opener at the joint, the method including positioning the elongate section of crustacean body, to be opened, such that a portion of the elongate section of crustacean body extends through the aperture at the joint.

In some embodiments, the method includes selecting, as the opener, an opener which is fabricated using food grade material, especially where the food grade material is selected from the group consisting of stainless steel, aluminum, titanium, coated steel, other cutlery-grade materials, and alloys of such metals.

In some embodiments, the moving of the first and second arms collectively toward each other comprises pivoting the first and second arms relative to each other about the joint.

In preferred embodiments, the method includes, upon completion of the cutting of the crustacean shell, releasing the first and second arms, whereupon the arms retract away from each other to a position generally parallel to each other.

In some embodiments the opener further comprises a meat extractor extending from at least one of the first and second arms, the meat extractor being sized and configured so as to facilitate entrance of the meat extractor into narrow section of the crustacean body, and generally conforming to the outline of the elongate section of crustacean body, the method further comprising inserting the meat extractor into the now-opened crustacean body such that the meat extractor fits generally inside, and generally conforms to, a transverse section of at least part of the crustacean body, and accordingly employing the meat extractor on the opener to extract meat from the opened crustacean body.

In some embodiments, the invention includes simultaneously employing first and second meat extractors, extending from respective ones of the first and second arms, in a pinching movement, to extract meat from the opened section of elongate crustacean body.

In a third family of embodiments, the invention comprehends a shell opener adapted to open elongate sections of crustacean shells. The opener comprises first and second arms, having first and second respective lengths, the first and second arms being connected to each other at a joint therebetween, and extending in a generally common direction from the joint; and a shell cutting blade extending from one of the first and second arms toward the other of the first and second arms, the opener being so configured, and the blade being so positioned, that fingers of a user of the opener are effectively shielded from the blade during routine use of the opener, thereby to substantially control risk of injury to such fingers of such user.

In some embodiments, the cutting blade is adapted to make an elongate cut along the elongate section of the crustacean shell as the elongate section is drawn along the length of the respective arm.

In preferred embodiments, the opener further comprises an aperture extending through the shell opener at the joint so as to enable extending an elongate section of crustacean shell through the aperture in general alignment with the first and second arms.

### BRIEF DESCRIPTION OF THE DRAWINGS

FIG. 1 shows a plan view of a metal blank which can be formed into a first embodiment of a crustacean shell opener of the invention.

FIG. 2 shows a pictorial view of a crustacean shell opener of the invention, made from the metal blank of FIG. 1.

FIG. 3 shows a side elevation of the shell opener of FIG. 2, with a crab leg, shown in dashed outline, positioned in the opener, in position to be opened.

FIG. 4 shows a pictorial view of a second embodiment of the invention, showing a crab leg therein, partially opened by the blade, and wherein the opener includes meat extractors, sized and configured for removal of the meat from the crustacean shell after the shell has been opened.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

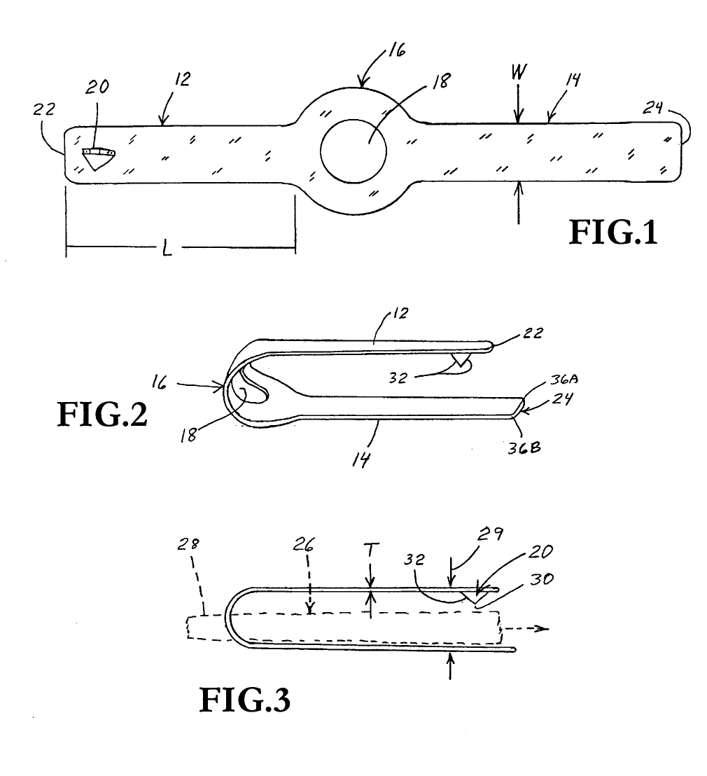

Referring to the blank illustrated in FIG. 1, shell opener 10 of the invention has first and second arms 12, 14, on opposing ends thereof. An joint 16, located between, and joined to, arms 12 and 14, is defined by an enlargement of the width of the blank, between arms 12 and 14. An aperture 18 is centrally located in joint 16. Arm 12 has a distal end 22 remote from joint 16. Arm 14 has a distal end 24 remote from joint 16. A cutting blade 20 is located generally toward distal end 22 of arm 12. Blade 20 extends upwardly in the illustration shown in FIG. 1.

As best seen in FIGS. 2 and 3, shell opener 10 is typically fabricated from a strip of relatively thin sheet metal having thickness “T” of, for example and without limitation, about 0.06 inch thick. Typical widths “W” of arms 12, 14 are, for example and without limitation, about 0.75 inch. Typical lengths “L” of arms 12, 14 are, for example and without limitation, about 3 inches, more or less, measured generally from the beginning of the enlargement which defines joint 16 to the distal ends 22, 24 of the respective arms. In the embodiments illustrated in FIGS. 1-3, arm 14 is about 0.25 to about 0.5 inch longer than arm 12, for reasons which will be explained in detail later in this description.

In making the conversion from the blank of FIG. 1 to the fabricated opener of FIGS. 2 and 3, the blank is folded about joint 16, onto itself, thus bringing arm 12 into overlying relationship relative to arm 14, thereby molding a permanent bend in the blank at joint 16. The finished opener, in the rest, unstressed position, is generally configured as depicted in FIGS. 2 and 3, where arms 12 and 14 extend from joint 16, in generally parallel relationship with each other, and where blade 20 extends from arm 12 toward arm 14. The folding of the blank is carried out about joint 16 such that aperture 18 is disposed at the apex of the fold between arms 12 and 14, namely at that location which is most remote from the distal ends 22 and 24 of arms 12 and 14.

In preferred embodiments, blade 20 is fabricated by making a V-shaped cut through the material of arm 12 at the location where a blade is desired. The material on the resultant male side of the cut is then formed to thereby create a tab which is oriented at an angle of about 90 degrees from the general lay of the surface of arm 12 adjacent the cut. The tab is sharpened as desired so as to facilitate using the tip of the tab for puncturing the shell, and using the front and rear edges of the tab, which face respectively away from and toward, joint 16, as cutting surfaces of a cutting blade, for making controlled linear cuts in crustacean shells, starting at the point where the shell is initially penetrated. The distal point of the “V” on the male side of the so-formed tab is inherently sharp by virtue of the shape of the material on the male side of the cut metal, and is therefore effective for puncturing crustacean shells. The edges of the material on the male side of the “V” are also sharpened as desired so that the edges can act as cutting edges for making linear cuts in crustacean shells after the point has provided the initial penetration through the thickness of the shell.

The material of shell opener 10 is selected so as to be formable, preferably cold-formable, from the flat blank condition of FIG. 1 to the folded condition of FIGS. 2 and 3 without breaking, crazing, flaking of coating, or otherwise being unacceptably weakened or damaged by such process so as to be unable to perform the functions required of a food-grade shell opener.

The material of shell opener 10 is further selected such that the formed opener is further resiliently deflectable from the folded position shown in FIGS. 2 and 3, for the purpose of penetrating, and making linear cuts in, crustacean shells. The opener is deflectable such that arms 12 and 14 can, in general, be brought together such that the distal ends 22, 24 of the arms are generally in contact with each other; and upon release of the arms, the arms resiliently return to the parallel condition shown in FIGS. 2 and 3. Thus, the arms 12, 14, from the parallel condition shown in FIGS. 2 and 3, can be pressed toward each other for the purpose of penetrating e.g. a crab leg, and forming a cut line in such crab leg; and then the arms return to the parallel relationship when the pressure is released.

The shell opener of the invention is used as follows. An elongate section of a crustacean shell 26, such as a crab leg, is placed between arms 12 and 14, and is aligned with the lengths of the arms, as illustrated in FIG. 3. Such shell section has a surrounding exo-skeletal structure, and internal meat contents. Thus, the shell section has, generally speaking, a top shell layer on top of the meat, a bottom shell layer below the meat, and shell sides beside the meat, and between the top and bottom shell layers. The top, bottom, and sides of the shell generally surround the meat and are connected to each other as a generally unitary shell, enclosing the cavity which contains the meat.

If the length of the shell section, from the point of planned blade entry into the shell, is longer than the distance between blade 20 and joint 16, for example a king crab leg, the additional portion of the length is readily extended through aperture 18 as shown at 28 in FIG. 3.

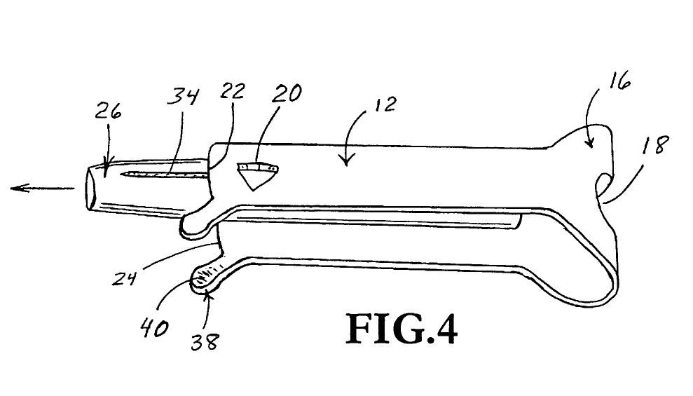

With the elongate shell section, such as the king crab leg, in place between arms 12, 14, the user squeezes arms 12, 14 toward each other as shown by arrows 29 in FIG. 3, thus forcing the puncturing lead end 30 of blade 20 into and through the top layer of the shell. With the blade having penetrated through the shell, and with continued squeezing of the arms toward each other so as to maintain the blade point inside the shell, the user pulls the crab leg 26 away from the blade, in a direction parallel to the directions of extension of arms 12, 14, preferably in the direction illustrated by the dashed horizontal arrow, away from joint 16. In a less preferred, but still viable alternative embodiment, the crab leg can be pulled in the opposite direction, toward joint 16 and through aperture 18. Since the length of the blade, and the cutting edge 32 of the blade, are aligned with the direction in which the leg is pulled, the movement of the leg relative to the blade causes the sharp cutting edge 32 of the blade to make a progressive linear cut in the shell as the leg/shell is pulled in the direction shown, away from arm 12 and through blade 20. The progression of the cut is shown in FIG. 4, described in more detail hereinafter, wherein slit 34 represents the cut in the shell which has been made as the leg is pulled through blade 20.

When the shell has been cut/slit along a satisfactory portion of the length of the shell, as determined by the user, arms 12, 14 are released and return to their retracted parallel positions; and the thus opened shell is removed from the opener. The slit/cut can then be manipulated open, or further broken as desired, so as to gain access to the meat inside. Once the shell is thus opened at slit 34, any of a number of conventionally-available meat picking tools can readily be used to retrieve the meat from the shell. However, it would be preferred that the opening of the shell, and the removal of the meat, be performed with a single easy-to-use tool.

As indicated above, in the embodiment of FIGS. 1-3, arm 14 is longer than arm 12, by about 0.25 to about 0.5 inch. Arm 14 thus protrudes beyond the end 22 of arm 12, whereby the corners 36A, 36B of end 24 of arm 14 are conveniently available to pick the meat out of the opened shell. To that end, FIG. 4 illustrates a second embodiment of the invention which is especially designed both for cutting the shell and for subsequently extracting the meat from the shell after the shell has been cut. The opener of FIG. 4 includes first and second opposing meat extractors 38. Meat extractors 38 are shown extending from corners of the distal ends 22, 24 of arms 12, 14. Since shell opener 10 is designed especially for opening elongate shell sections such as legs, the depth of the shell section to be opened is relatively small. Since the depth of the shell section is relatively small, the lengths of meat extractors 38 need not be very long. Typically, meat extractors 38 are no more than 1 inch long, with preferred lengths, to the distal tips of the meat extractors, being in the range of about 0.5 inch to about 0.75 inch, measured from the imaginary intersection of the end, 22 or 24, of the respective arm with the longitudinally-extending outer edge of that arm. In use, meat extractors 38 can be used individually to remove meat from the shell, or can be used together to pinch a piece of meat, thereby to grasp the meat for extraction from the shell. The surfaces 40 of extractors 38, which surfaces face each other, are the surfaces which are used in pinching operations. Surfaces 40 can be roughened as desired such as by coining, serrating, and the like, to enhance the ability of these surfaces to grip the meat.

Extractors 38 are shown extending at an angle of about 45 degrees from the direction of extension of arms 12, 14, and are located at corners of the ends of the arms. The angle can be any angle desired by the designer of the particular opener 10, whether more or less than the 45 degrees shown, and can indeed extend e.g. back toward joint 16 if desired, or e.g. directly outward from the ends of the arms, as straight-line extensions of the arms, albeit of lesser widths than the widths “W” of the arms.

Further to use of the openers of the invention, the crab leg or other crustacean section is inserted between the first and second arms, facing toward the aperture. The leg is inserted as far into and through the aperture as desired. The arms are then squeezed together thereby to cause blade 20 to penetrate into and through the exo-skeleton of the crab leg. With the blade extending into/through the crab leg exo-skeleton, the leg is then drawn through the tool for a substantial distance, thereby making a relatively straight-line cut in the crab leg, the cut extending along the length of the leg.

Since the blade makes a progressive linear cut, little or no pieces of shell of substantial size break away from the main body of the enclosing exo-skeletal shell. While microscopic particles of shell are broken away in the process of making cut or slit 34, only a very limited amount of macro-size shell pieces break away from the main body of the shell. Thus, the quantity of objectionable shell pieces which fall onto the meat is reduced by at least 50%, preferably at least 75%, to a level where an ordinary consumer of such shellfish meat readily recognizes the reduction which is related to entering the shell using a linear cutting of the shell, rather than a crushing type entry to the shell. Typically, the rate of contamination of the meat, namely the rate at which pieces of shell fall onto the meat as the shell is being opened and the meat extracted, is reduced to the extent where an ordinary user of such shellfish meat finds substantially no objectionable pieces of shell in the meat.

With an elongate cut thus made, of known and controlled direction, namely a rather lengthy, relatively straight line cut, the user can then readily pry the elongate section of the shell open along the elongate cut, whereby the meat inside is exposed. With the exo-skeleton thus open, one of corners 36A, 36B of relatively longer arm 14 of stripper 10 can be used as a spoon of sorts to remove the exposed meat. The thus slit crab leg is also, of course, susceptible of being removed by extractors 38, as described above.

In an embodiment not shown, arms 12, 14 can be fabricated with facing concave surfaces, through preferably generally straight lengths, whereby corners 36A, 36B may function even better in their capacities as spoons. Such concavities also tend to better retain the typical arcuately-shaped crab leg, centered across the widths “W” of arms 12, 14.

In addition to opening crab legs, opener 10 can be used to open crab claws, and/or any other exo-skeletal element of such crustaceans; for example lobster and/or lungusta legs, and the like, so long as the open distance “D” between arms 12 and 14 is, or can be made to be, great enough that the shell element to be opened can be inserted between the arms with sufficient freedom that blade 20 can penetrate the shell at the desired location to initiate the cutting of the shell.

While a number of materials can be contemplated for use in making opener 10, whatever material is used must be safe for use in direct contact with food intended for human consumption. In that regard, and considering cost of materials, the preferred material is stainless steel, in grades which are capable of being formed in the manner indicated, and which can subsequently be flexed a large number of times in use, as at arrows 29, without damage. In addition, the material must be either disposable (such as a plastic) or must be susceptible of restaurant-temperature washings. While some plastic materials may satisfy the safety requirements and/or the temperature requirements, and may also satisfy sharpness requirements for penetration and cutting, at least for short-term use as disposable openers, metals are preferred. Such metals are necessarily food-grade materials, and are typically selected from the group consisting of stainless steel, aluminum, titanium, coated steel, other cutlery-grade materials, and alloys of such metals. For reasons of cost-effectiveness and consumer acceptance, stainless steel is preferred. Of course, any of the coated steels, which are known for cutler use, can also be used.

Thus, it is seen that the invention provides the ability to open a crustacean shell using an initial point penetration, followed by a linear cut, in a hand held tool which is readily manipulated, employed by the consumer of such comestibles, at the point of consumption, e.g. at the table. Such point of entry, followed by linear cut, opens the shell to removal of the meat, or to further breakage of the shell, without generating an objectionable quantity of shell pieces dropping into the meat contained within the shell. As a result, an increased quantity of meat, otherwise often wasted, is retrieved from the typical crab animal. Further, the crab meat so retrieved, contains lesser quantity, if any, of objectionable shell material, where the meat so retrieved is of higher quality, thus of greater value, than is otherwise typically achieved.

Further, the opener 10 of the invention is so designed and configured as to shield the fingers and other body parts of the user from risk of unintended contact with blade 20, either point 30 or cutting edges 32, while opening a crustacean shell. I As seen at FIGS. 3 and 4, at no time while a shell is being penetrated or cut is there any force tending to urge any un-masked body part of the user toward blade 20, or blade 20 toward an unshielded body part of the user. For example, with e.g. a right-hand dominant user, opener 10 is held in the left hand. While the left hand is proximate blade 20, and while the fingers of the left hand may be urged toward blade 20 as the leg is pulled through blade 20, the edges of the sides and ends of arms 12, 14 protect/shield the fingers of the left hand from blade 20; and the fingers of the right hand are pulling away from blade 20, whereby the direction of the pulling force precludes any blade injury to the right hand.

In an embodiment not shown, the invention contemplates openers wherein arms 12, 14 are made of rigid, noon-resilient material. Resilient joint 16 is replaced by a pivoting hinge-style joint, e.g. pivoting about a pivot pin. A conventional spring, e.g. a coil spring or leaf spring provides the resilient return to parallelism of arms 12, 14, against a stop, upon release of arms 12, 14 from a cutting action. Arm 12 can have a blade holder which receives a blade 20 as a separate replaceable element of the opener. The hinged joint section still preferably includes aperture 18 unless arms 12, 14 are long enough to receive all contemplated lengths of shell sections e.g. crab legs. Such embodiment would be expected to be employed largely in high volume environments, such as institutional or commercial environments, and is less likely to be used in restaurant or consumer retail environments.

As used herein, and in the claims which follow, the phrase “macro-size pieces”, referring to crustacean shell, means shell pieces of such size and configuration which, if contaminating the shellfish meat, would be objectionable to an average consumer of such shellfish meat.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. A shell opener, adapted to open elongate sections of crustacean shells, said shell opener comprising:
(a) first and second arms, having first and second respective lengths, said first and second arms being connected to each other at a joint therebetween, and extending in a generally common direction from the joint; and
(b) a shell cutting blade extending from one of said first and second arms toward the other of said first and second arms, said opener being so configured, and said blade being so positioned, that fingers of a user of said opener are effectively shielded from said blade during routine use of said opener, thereby to substantially control risk of injury to such fingers of such user.

2. A shell opener as in claim 1 wherein said cutting blade is adapted to make an elongate cut along such elongate section of crustacean shell as such elongate section is drawn along the length of the respective said arm of said shell opener.

3. A shell opener as in claim 1, further comprising an aperture extending through said shell opener at the joint so as to enable extending an elongate section of crustacean shell through the aperture in general alignment with said first and second arms of said shell opener.

4. A shell opener as in claim 1, said shell opener being fabricated from food grade material suitable for contact with foodstuffs.

5. A shell opener as in claim 4 wherein the food grade material is selected from the group consisting of stainless steel, aluminum, titanium, coated steel, other cutlery-grade materials, and alloys of such metals.

6. A shell opener as in claim 1 wherein said shell cutting blade extends from, and is integral with, the respective said arm.

7. A shell opener as in claim 1, said first arm extending a first distance from the joint to the first distal end, said second arm extending a second distance from the joint to the second distal end, the first distance being greater than the second distance, whereby a section of the first arm extends beyond the second distal end of the second arm.

8. A shell opener as in claim 7, the section of said first arm which extends beyond said second arm being configured to retrieve leg meat from narrow openings in crab legs.

9. A shell opener as in claim 1, said cutting blade being positioned and configured, relative to the respective one of said arms such that said cutting blade is brought into cutting engagement with a respective crustacean shell, which is positioned between the first and second arms, by urging the distal ends of the first and second arms toward each other.

10. A shell opener as in claim 1 wherein the cutting blade, in cutting the shell, applies force directed inwardly into the respective section of crustacean shell.

11. A shell opener as in claim 1, further comprising at least one meat extractor extending from a respective one of said first and second arms, said meat extractor terminating at an end thereof wherein, if first and second extractors are used on the first and second arms, respective first and second said meat extractors are opposed to each other such that said meat extractors can be brought together in a pinching relationship with respect to each other.

12. A shell opener as in claim 1, said meat extractors extending from said arms in directions transverse to the lengths of said first and second arms.

13. A shell opener as in claim 10, said meat extractors extending no more than one inch from said arms.

14. A shell opener, adapted to open elongate sections of crustacean shells, said shell opener comprising:
(a) first and second arms, having first and second respective lengths, said first and second arms being connected to each other at a joint therebetween, and extending in a generally common direction from the joint, said first arm having a first distal end remote from the joint, said second arm having a second distal end remote from the joint; and
(b) a shell cutting blade extending from one of said first and second arms toward the other of said first and second arms such that said cutting blade is adapted to make an elongate cut along the elongate section of crustacean shell as such elongate section is drawn along the length of the respective said arm.

15. A shell opener as in claim 14, said shell opener being fabricated from food grade material suitable for contact with foodstuffs.

16. A shell opener as in claim 14, said first and second arms being sufficiently resiliently flexible to enable a user thereof to bring said first and second arms together, thereby to penetrate said cutting blade into a crustacean shell positioned between said first and second arms.

17. A shell opener as in claim 15, said first and second arms being sufficiently resiliently flexible to enable a user thereof to bring said first and second arms together, thereby to penetrate said cutting blade into a crustacean shell positioned between said first and second arms.

18. A shell opener as in claim 14 wherein said shell cutting blade extends from, and is integral with, the respective said arm.

19. A shell opener as in claim 15 wherein the food grade material is selected from the group consisting of stainless steel, aluminum, titanium, coated steel, other cutlery-grade materials, and alloys of such metals.

20. A shell opener as in claim 14, said first arm extending a first distance from the joint to the first distal end, said second arm extending a second distance from the joint to the second distal end, the first distance being greater than the second distance, whereby a section of the first arm extends beyond the second distal end of the second arm.

21. A shell opener as in claim 20, the section of said first arm which extends beyond said second arm being configured to retrieve leg meat from narrow openings in crab legs.

22. A shell opener as in claim 14, said cutting blade being positioned and configured, relative to the respective one of said arms such that said cutting blade is brought into cutting engagement with a respective crustacean shell, which is positioned between the first and second arms, by urging the distal ends of the first and second arms toward each other.

23. A shell opener as in claim 22, the urging of the distal ends of the first and second arms toward each other comprising pivoting the first and second arms relative to each other about the joint.

24. A shell opener as in claim 14 wherein the blade, in cutting the shell, applies force directed inwardly into the respective section of crustacean shell.

25. A shell opener as in claim 14 wherein said first and second arms, at rest, are biased away from each other, and are generally parallel to each other.

26. A shell opener as in claim 14, said shell cutting blade being located on the respective said arm at a location remote from the joint.

27. A shell opener as in claim 14, said first and second arms comprising a unitary piece of material which extends, uninterrupted, through the joint.

28. A shell opener as in claim 14, further comprising at least one meat extractor extending from a respective one of said first and second arms, said meat extractor terminating at an end thereof and wherein, if first and second meat extractors are used on said first and second arms, respective first and second said meat extractors are opposed to each other such that said meat extractors can be brought together in a pinching relationship with respect to each other.

29. A shell opener as I claim 28, said at least one meat extractor being sized and configured so as to facilitate entrance of said at least one meat extractor into narrow sections of crab leg, with said at least one meat extractor generally conforming to typical outlines of such narrow sections of crab leg, said at least one meat extractor being effective for extracting crab meat from such narrow sections of crab leg.

30. A shell opener as in claim 28, said meat extractors extending from said arms in directions transverse to the lengths of said first and second arms.

31. A shell opener as in claim 28, said meat extractors extending no more than one inch from said arms.

32. A shell opener as in claim 14 wherein said first and second arms have respective first and second ends, and wherein said first and second arms are inwardly curved proximate the first and second ends so that facing surfaces of said first and second arms proximate the ends are concave, thereby to generally conform to a typically rounded outline of elongate sections of crustacean shells to be opened therewith.

33. A shell opener as in claim 14, further comprising an aperture extending through said shell opener at the joint so as to enable extending an elongate section of crustacean shell through the aperture in general alignment with said first and second arms, of said shell opener.

34. A shell opener as in claim 15, further comprising an aperture extending through said shell opener at the joint so as to enable extending an elongate section of crustacean shell through the aperture in general alignment with said first and second arms, of said shell opener.

35. A shell opener as in claim 34, said shell cutting blade having an effective cutting edge facing at least one of toward, or away from, the aperture.

36. A shell opener as in claim 14 wherein said first and second arms are biased away from each other against a stop.

37. A method of opening an elongate section of a crustacean body, having a first length, the method comprising:
(a) aligning the unopened elongate section of the crustacean body with first and second arms of a opener for such crustacean bodies, and between the first and second arms,
(i) the first and second arms having first and second respective lengths, and being connected to each other at a joint therebetween, and extending in a generally common direction from the joint, and
(ii) a shell cutting blade extending from one of the first and second arms toward the other of the first and second arms;
(b) applying a force which moves the first and second arms collectively toward each other to a relatively more closed position wherein the blade penetrates the crustacean body which is to be opened; and
(c) drawing the section of crustacean body in a direction along the lengths of the arms, with the cutting blade maintained in cutting relationship with the crustacean body,
whereby the drawing of the crustacean body in the direction of the lengths of the arms, with the cutting blade maintained in cutting relationship with the crustacean body draws the shell into and through a cutting relationship with the blade and thereby effects cutting of an elongate slit along the length of the elongate section of the crustacean body.

38. A method as in claim 37 wherein the blade cuts an elongate slit without breaking off macro-size pieces of shell of the crustacean body.

39. A method as in claim 37, the opener further comprising meat extractors extending from the first and second arms, the meat extractors terminating at ends thereof which are opposed to each other, such that the meat extractors can be brought together in a pinching relationship with respect to each other, the meat extractors being sized and configured so as to facilitate entrance of the meat extractors into narrow sections of the crustacean body, with the meat extractors generally conforming to the outlines of the narrow sections of the crustacean body, the method further comprising using the meat extractors of the opener to extract meat from the elongate section of the crustacean body.

40. A method as in claim 37, the opener further comprising an aperture extending through the opener at the joint, the method including positioning the elongate section of crustacean body, to be opened, such that a portion of the elongate section of crustacean body extends through the aperture at the joint.

41. A method as in claim 37 including selecting, as the opener, an opener which is fabricated using food grade material.

42. A method as in claim 41 wherein the food grade material is selected from the group consisting of stainless steel, aluminum, titanium, coated steel, other cutlery-grade materials, and alloys of such metals.

43. A method as in claim 37, the moving of the first and second arms collectively toward each other comprising pivoting the first and second arms relative to each other about the joint.

44. A method as in claim 37 including, upon completion of the cutting of the crustacean shell, generally releasing the force from the first and second arms, whereupon the arms retract away from each other to a position generally parallel to each other.

45. A method as in claim 37, the opener further comprising a meat extractor extending from at least one of the first and second arms, the meat extractor being sized and configured so as to facilitate entrance of the meat extractor into a narrow section of the crustacean body, and generally conforming to the outline of the elongate section of crustacean body, the method further comprising inserting the meat extractor into the now-opened crustacean body such that the meat extractor fits generally inside, and generally conforms to, a transverse section of at least part of the crustacean body, and accordingly employing the meat extractor on the opener to extract meat from the opened crustacean body.

46. A method as in claim 37, including simultaneously employing first and second meat extractors, extending from respective ones of the first and second arms, in a pinching movement, to extract meat from the opened section of elongate crustacean body.
